(19) United States
(12) Patent Application Publication
(10) Pub. No.: US 2013/0145095 A1
(43) Pub. Date: Jun. 6, 2013

(54) MELTHOD AND SYSTEM FOR INTEGRATING THE FUNCTIONS OF A CACHE SYSTEM WITH A STORAGE TIERING SYSTEM

(71) Applicants: Brian McKean, Longmont, CO (US); Gerald J. Fredin, Wichita, KS (US)

(72) Inventors: Brian McKean, Longmont, CO (US); Gerald J. Fredin, Wichita, KS (US)

(73) Assignee: LSI CORPORATION, Milpitas, CA (US)

(21) Appl. No.: 13/312,473

(22) Filed: Dec. 6, 2011

(51) Int. Cl. G06F 12/08

(52) U.S. Cl. 711/122; 711/E12.017

(57) ABSTRACT

A tiered data storage system having a cache employs a tiering management subsystem to analyze data access patterns over time, and a cache management subsystem to monitor individual input/output operations and replicate data in the cache. The tiering management subsystem determines a distribution of data between tiers and determines what data should be cached while the cache management subsystem moves data into the cache. The tiered data storage system may analyze individual input/output operations to determine if data should be consolidated from multiple regions in one or more data storage tiers into a single region.

### FIELD OF THE INVENTION

The present invention is directed generally toward data storage systems, and more particularly to tiered data storage systems having at least one cache.

### BACKGROUND OF THE INVENTION

Storage systems can use a variety of mechanisms to preferentially increase the performance of data access operations. Two methods in use today include the use of storage system caches and the use of storage system tiering subsystems.

Storage and file systems that use a storage tiering subsystem are relatively new to the storage system marketplace. These systems typically offer two tiers of storage; a higher cost, higher performance storage medium and a lower cost, lower performance storage medium. Data access patterns are analyzed over time and some of the data is selected to be moved to the higher performance storage medium, while at the same time some other data is moved, in exchange, to the lower performance storage medium. Typically data resides on a single tier at any one time. The data access pattern analysis is performed over hours or days to ensure that the overhead of moves is kept to a minimum.

Cache subsystems in storage systems use two or more media varying in cost and performance from a highest cost, highest performance cache such as DRAM to a lowest cost, lowest performance medium, such as hard disk drives (HDDs). Data access is typically monitored with each input/output (I/O) process transaction. With each I/O transaction, the cache subsystem decides where to leave the copy of the data at the conclusion of the I/O transaction. With caching, there is a base performance tier, which maintains a copy of all the data, and each cache level may contain a copy of the data with the highest performing tier containing the most recent copy.

There are variations wherein some caches may contain only data for read I/O transactions, others only for write I/O transactions and others for both read and write I/O transactions.

A cache subsystem would be more effective in terms of overall performance if, in addition to monitoring I/O transactions, the cache subsystem cached data based on long term monitoring. Similarly, a tiering subsystem would be more effective in terms of overall performance if the tiering subsystem could utilize the cache subsystem's data movement capability. Consequently, it would be advantageous if an apparatus existed using long term monitoring facilities in a tiering subsystem to determine what data should be cached, and using a cache subsystem to move data between tiers.

### SUMMARY OF THE INVENTION

Accordingly, the present invention is directed to a novel method and apparatus for using long term monitoring facilities in a tiering subsystem to determine what data should be cached, and using a cache subsystem to move data between tiers.

One embodiment of the present invention is a computer system executing a thread for managing one or more cache systems and a thread for managing a tiering data storage system. The thread for managing the tiering data storage system performs ongoing analysis of data access patterns and the thread managing the one or more cache systems uses the data produced by the ongoing analysis to determine what data should be cached.

Another embodiment of the present invention is a computer system having a tiering subsystem and a cache subsystem where a cache is partitioned for use by both the cache subsystem and the tiering subsystem to move data among tiered data storage devices.

Another embodiment of the present invention is a computer system having a first processor executing a thread for managing one or more cache systems and a second processor executing a thread for managing a tiering data storage system. The second processor performs ongoing analysis of data access patterns and the first processor uses the data produced by the ongoing analysis to determine what data should be cached.

Another embodiment of the present invention is a method, performed by a tiered data storage computer system, for managing data in a cache. The method includes analyzing data access patterns over time using a data analysis mechanism incorporated into a tiering subsystem, and replicating data in a cache using an analysis produced by the tiering subsystem.

It is to be understood that both the foregoing general description and the following detailed description are exemplary and explanatory only and are not restrictive of the invention claimed. The accompanying drawings, which are incorporated in and constitute a part of the specification, illustrate an embodiment of the invention and together with the general description, serve to explain the principles.

### BRIEF DESCRIPTION OF THE DRAWINGS

The numerous objects and advantages of the present invention may be better understood by those skilled in the art by reference to the accompanying figures in which:

FIG. 1 shows a block diagram of a tiered data storage system having multiple process threads for managing a data cache and data tiering;

FIG. 2 shows a block diagram of a tiered data storage system having multiple processors for managing a data cache and data tiering; and

FIG. 3 shows a flowchart of a method for determining a distribution of data in a data storage system having a cache and multiple data storage tiers.

### DETAILED DESCRIPTION OF THE INVENTION

Reference will now be made in detail to the subject matter disclosed, which is illustrated in the accompanying drawings. The scope of the invention is limited only by the claims; numerous alternatives, modifications and equivalents are encompassed. For the purpose of clarity, technical material that is known in the technical fields related to the embodiments has not been described in detail to avoid unnecessarily obscuring the description.

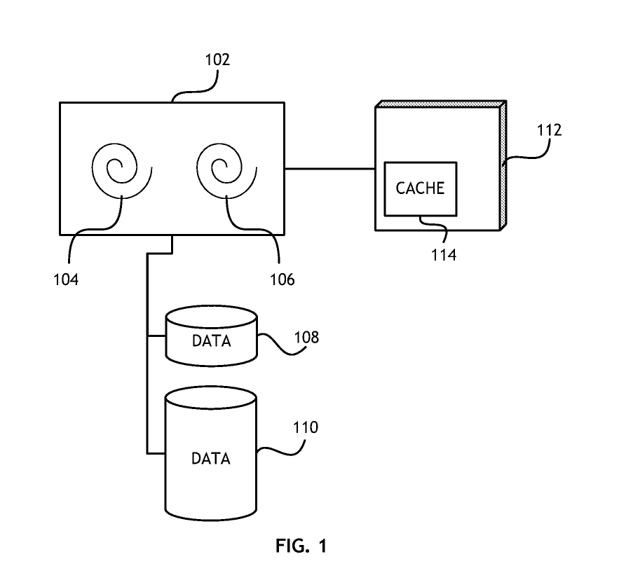

Referring to FIG. 1, a tiered data storage system is shown. The tiered data storage system may include a processor 102 executing a tiering management thread 104 and a cache management thread 106. The processor 102 may be connected to one or more tiered data storage devices 108, 110. The tiered data storage devices may include a fast data storage tier 108 and a slow data storage tier 110. The fast data storage tier 108 may be implemented using data storage technology such as solid state drives (SSD), flash, or any technology with relatively faster performance characteristics as compared to the slow data storage tier 110. The slow data storage tier 110 may be implemented using data storage technology such as SATA or SCSI hard disk drives (HDD) or any other technology with relatively slower performance characteristics as compared to the fast data storage tier 108. One skilled in the art will appreciated that in the present context, “fast” and “slow” refer only to the relative performance of the technology used to implement the fast data storage tier 108 and slow data storage tier 110. The tiered data storage system may also include a memory 112 connected to the processor 102. The memory may be implemented using technology suitable for use as random access memory (RAM). The tiered data storage system may also include a cache 114. The cache 114 may be implemented in the memory 112, as illustrated in FIG. 1, or the cache 114 may be implemented in the fast data storage tier 108.

In the tiered data storage system, data may be distributed between a slow data storage tier 110 and a fast data storage tier 108. Data distribution between the slow data storage tier 110 and the fast data storage tier 108 may be based on data block access patterns measured over a period of time. Periods of time for analyzing data access patterns to determine a distribution may be on the order of hours, days or longer depending on the data; one skilled in the art will appreciated that periods of time for data access pattern analysis may vary. The tiering management thread 104 may record data block access operations (read and/or write operations) for each region or data block in the slow data storage tier 110 and the fast data storage tier 108. Data blocks are uniformly sized, logical divisions of the physical media in a data storage device. The tiering management thread 104 may maintain metadata associated with each data block and update the metadata in response to each data block access operation. For the tiered data storage system to be effective, it must maintain frequently accessed data blocks (hot data blocks) on the fast data storage tier 108. The tiering management thread 104 may determine which data blocks are hot by referencing the metadata maintained for each data block. When the tiering management thread 104 has determined which data blocks are hot, it may move data blocks from the slow data storage tier 110 to the fast data storage tier 108 and from the fast data storage tier 108 to the slow data storage tier 110.

In a data storage system having a cache 114, a cache management thread 106 may monitor individual IO operations and maintain metadata associated with data accessed during each of the individual IO operations. When, based on the metadata, the cache management thread 106 determines that certain data is likely to be subjected to subsequent IO operations, the cache management thread 106 may replicate the data to the cache 114. Because the cache 114 may be implemented with faster technology than either the slow data storage tier 110 or the fast data storage tier 108, data replicated in the cache 114 may be read quicker than data stored in either data storage tier. Because cache is often implemented with volatile memory technology, data written to a cache may be vulnerable to a power loss until the cache is flushed to a persistent data storage device, in this case data written to a cache must be frequently flushed to ensure power fault tolerance. Therefore, one example of a criteria for determining what data should be replicated in the cache 114 may be frequent read operations but infrequent write operations.

In a tiered data storage system according to at least one embodiment of the present invention, the tiering management thread 104 may analyze data block access patterns over time to determine what data should be replicated in the cache 114. Using a tiering management thread 104 to determine what data should be cached allows the tiered data storage system to cache data more efficiently as compared to the prior art because it may alleviate the otherwise necessary overhead of the cache management thread 106 monitoring and making caching determinations based on every IO operation. Using a tiering management thread 104 to determine what data should be cached may provide efficiencies in overall data storage such as preventing data on the fast data storage tier 108 from being replicated in the cache 114, or analyzing the effectiveness of the cache 114 in reducing IO operations to the slow data storage tier 110.

Alternatively, a tiered data storage system may utilize both a data access pattern analysis performed by the tiering management thread 104 and an individual IO operations analysis performed by the cache management thread 106 to determine a distribution of data to the slow data storage tier 110, the fast data storage tier 108 and the cache 114. For example, the cache management thread 106 may determine that several IO operations accessing a certain piece of data are queued; therefore, the data should be cached to improve immediate access time for the queued IO operations. However, the tiering management thread 104 may determine that the data block containing the certain piece of data has become hot. In that situation, the tiering management thread 104 and the cache management thread 106 may interact to determine that it would be more efficient to move the data block containing the certain piece of data to the fast data storage tier 108 than to cache the data. Such determination may be based on information not otherwise available to either thread independently.

The tiering management thread 104 and cache management thread 106 may also interact to move data between data storage tiers 108, 110. The cache 114 may be partitioned into a cache partition and a tier partition. The cache partition may be utilized by the cache management thread 106 to cache data. The tier partition may be utilized by the cache management thread 106 and the tiering management thread 104 to move data from the fast data storage tier 108 to the slow data storage tier 110, or from the slow data storage tier 110 to the fast data storage tier 108. The tiering management thread 104, or the tiering management thread 104 and cache management thread 106 in concert, may determine a distribution of data among the data storage tiers 108, 110 based on data access patterns. The tiering management thread 104 may then direct the cache management thread 106 to move data between the fast data storage tier 108 and the slow data storage tier 110 according to the distribution, utilizing the tier partition of the cache 114 as an intermediary location. Utilizing the cache management thread's 106 native data movement mechanisms to move data between data storage tiers 108, 110 may provide efficiency over the prior art by consolidating data movement operations in the cache management thread 106.

In another example, where the tiering management thread 104 determines that a certain data block has become hot over a period of time, the tiering management thread 104 may ordinarily move the certain data block to the fast data storage tier 108. However, the cache management thread 106 may determine that all or nearly all of the IO operations to the certain data block are read operations; the tiering management thread 104 and the cache management thread 106 may interact to determine that it would be more efficient to cache the data in the certain data block and leave the data on the slow data storage tier 110 to leave room on the fast data storage tier 108 for other data blocks.

In another example, the cache management thread 106 may determine that certain data in separate data blocks is frequently accessed together, while the tiering management thread 104 may determine that one data block is hot while the other data block is cold. In that situation, the tiering management thread 104 and the cache management thread 106 may interact to determine that it would be efficient to combine the certain data into a single data block. The tiering management thread 104 may combine the certain data into a single data block on either the fast data storage tier 108 or the slow data storage tier 110 and the cache management thread 106 may replicate the certain data in the cache 114.

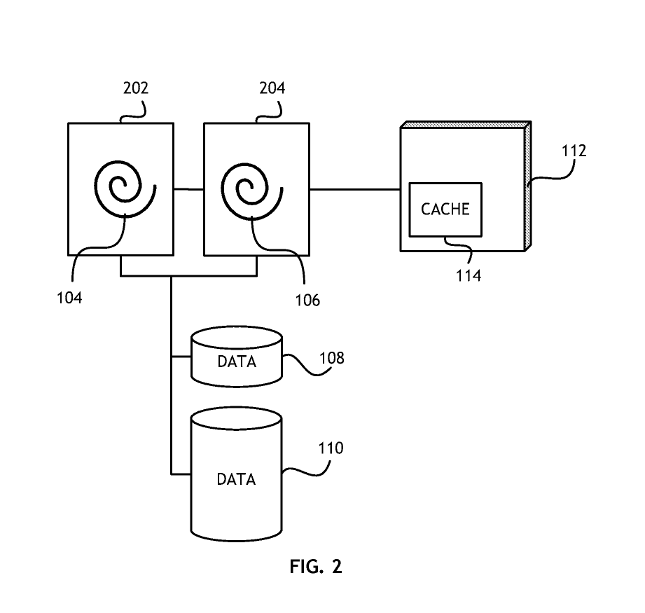

Referring to FIG. 2, another embodiment of a tiered data storage system is shown. The tiered data storage system may include a tiering management processor 202 executing a tiering management thread 104 and a cache management processor 204 executing a cache management thread 106. The tiering management processor 202 and cache management processor 204 may be connected to one or more tiered data storage devices 108, 110. The tiered data storage devices may include a fast data storage tier 108 and a slow data storage tier 110. The fast data storage tier 108 may be implemented using data storage technology such as solid state drives (SSD), flash, or any technology with relatively faster performance characteristics as compared to the slow data storage tier 110. The slow data storage tier 110 may be implemented using data storage technology such as SATA or SCSI hard disk drives (HDD) or any other technology with relatively slower performance characteristics as compared to the fast data storage tier 108. One skilled in the art will appreciated that in the present context, “fast” and “slow” refer only to the relative performance of the technology used to implement the fast data storage tier 108 and slow data storage tier 110. The tiered data storage system may also include a memory 112 connected to one or more of the tiering management processor 202 and cache management processor 204. The memory may be implemented using technology suitable for use as random access memory (RAM). The memory 112 may include a cache 114. The tiering management processor 202 and cache management processor 204 may be separate cores in a single central processing unit (CPU), separate CPUs in a server, separate CPUs in separate computers connected to a network, or any other configuration otherwise consistent with the features of the present invention.

In a tiered data storage system according to at least the embodiment of the present invention shown in FIG. 2, the tiering management thread 104 may analyze data block access patterns over time to determine what data should be replicated in the cache 114. Alternatively, a tiered data storage system may utilize both a data access pattern analysis performed by the tiering management thread 104 and an individual IO operations analysis performed by the cache management thread 106 to determine a distribution of data to the slow data storage tier 110, the fast data storage tier 108 and the cache 114. Using a tiering management thread 104 to determine what data should be cached allows the tiered data storage system to cache data more efficiently as compared to the prior art because it may alleviate the otherwise necessary overhead of the cache management thread 106 monitoring and making caching determinations based on every IO operation. Using a tiering management thread 104 to determine what data should be cached may provide efficiencies in overall data storage such as preventing data on the fast data storage tier 108 from being replicated in the cache 114, or analyzing the effectiveness of the cache 114 in reducing IO operations to the slow data storage tier 110. One skilled in the art will appreciate that the embodiment of the resent invention shown in FIG. 2 shares certain elements with the embodiment shown in FIG. 1. Those elements have not been described in regards to FIG. 2 in order to avoid unnecessary duplication.

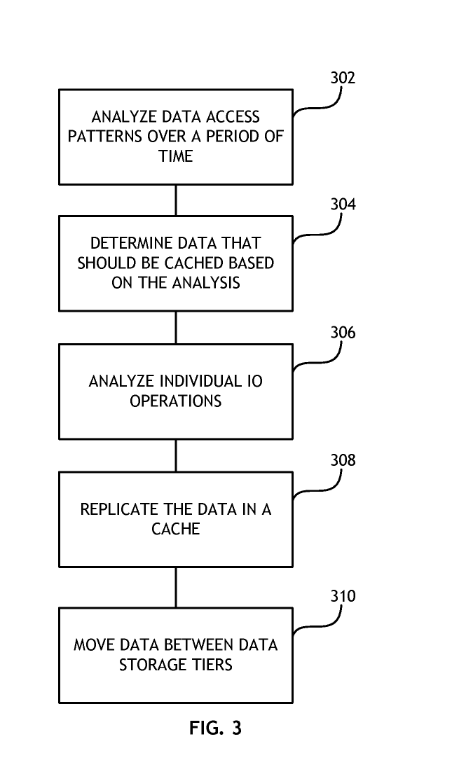

Referring to FIG. 3, a flowchart is shown for a method of determining a distribution of data in a tiered data storage system. A tiering management thread (such as the tiering management thread 104 in FIG. 1 and FIG. 2) in a tiered data storage system may analyze 302 data block access patterns over time to determine 304 what data should be replicated in a cache. A cache management thread (such as the cache management thread 106 in FIG. 1 and FIG. 2) may then replicate 308 the data from one or more data storage tiers to a cache. Using a tiering management thread to determine what data should be cached allows the tiered data storage system to cache data more efficiently as compared to the prior art because caching decisions made according to the present invention may be based on both immediate information from individual IO operations, and on long term usage. Using a tiering management thread to help determine what data should be cached may provide efficiencies in overall data storage such as preventing data on a fast data storage tier from being replicated in a cache, or analyzing the effectiveness of a cache in reducing IO operations to a slow data storage tier.

The cache management thread in the data storage system may analyze 306 individual IO operations. The tiering management thread and cache management thread may then interact to determine a distribution of data to a slow data storage tier, a fast data storage tier and a cache. For example, the cache management thread may determine that several IO operations accessing a certain piece of data are queued; therefore, the data should be cached to improve immediate access time for the queued IO operations. However, the tiering management thread may determine that the data block containing the certain piece of data has become hot. In that situation, the tiering management thread and the cache management thread may interact to determine that it would be more efficient to move 310 the data block containing the certain piece of data to a fast data storage tier than to cache the data. Such determination may be based on information not otherwise available to either thread independently.

In another example, where the tiering management thread determines that a certain data block has become hot over a period of time, the tiering management thread may ordinarily move the certain data block to a fast data storage tier. However, the cache management thread may determine that all or nearly all of the IO operations to the certain data block are read operations; the tiering management thread and the cache management thread may interact to determine that it would be more efficient to replicate 308 the data in the certain data block in cache and leave the data on a slow data storage tier to leave room on a fast data storage tier for other data blocks.

In another example, the cache management thread may determine that certain data in separate data blocks is frequently accessed together, while the tiering management thread may determine that one data block is hot while the other data block is cold. In that situation, the tiering management thread and the cache management thread may interact to determine that it would be efficient to move 310 the certain data into a single data block. The tiering management thread 104 may move 310 the certain data into a single data block on either a fast data storage tier or a slow data storage tier and the cache management thread may replicate 308 the certain data in a cache.

It is believed that the present invention and many of its attendant advantages will be understood by the foregoing description, and it will be apparent that various changes may be made in the form, construction, and arrangement of the components thereof without departing from the scope and spirit of the invention or without sacrificing all of its material advantages. The form herein before described being merely an explanatory embodiment thereof, it is the intention of the following claims to encompass and include such changes.

What is claimed is:

1. A tiered data storage apparatus comprising:
a processor;
memory connected to the processor, said memory configured as a cache;
a fast data storage tier connected to the processor;
a slow data storage tier connected to the processor; and
software executing on the processor,
wherein the software is configured to:
execute a tiering management thread, said tiering management thread configured to:
analyze data access operations of the fast data storage device and the slow data storage device over a period of time; and
determine a distribution of data based on an analysis of data access operations; and
execute a cache management thread, said cache management thread configured to replicate data from at least one of the fast data storage device and the slow data storage device to the cache based the distribution of data determined by the tiering management thread.

2. The apparatus of claim 1, wherein the cache management thread is further configured to analyze individual input/output operations.

3. The apparatus of claim 2, wherein the cache management thread is further configured to identify data from two or more regions of at least one of the fast data storage tier and the slow data storage tier that would be more efficiently accessed if stored in a single region.

4. The apparatus of claim 3, wherein the cache management thread is further configured to combine the data from the two or more regions into a single region.

5. The apparatus of claim 3, wherein the tiering management thread is further configured to combine the data from the two or more regions into a single region.

6. The apparatus of claim 2, wherein the tiering management thread is further configured to modify the distribution based on the input/output operations analysis.

7. The apparatus of claim 1, wherein the tiering management thread is further configured to move data between the fast data storage tier and the slow data storage tier in response to a data access operations analysis.

8. The apparatus of claim 1, wherein the cache management thread is further configured to replicate data only from the slow data storage tier.

9. A tiered data storage system comprising:
a tiering management processor;
a cache management processor connected to the tiering management processor;
memory connected to at least one of the tiering management processor and the cache management processor, at least a portion of said memory configured as a cache;
a fast data storage tier connected to the tiering management processor;
a slow data storage tier connected to the tiering management processor;
software executing on the tiering management processor; and
software executing on the cache management processor,
wherein:
the software executing on the tiering management processor is configured to:
analyze data access operations of the fast data storage device and the slow data storage device over a period of time; and
determine a distribution of data based on an analysis of data access operations; and
the software executing on the cache management processor is configured to replicate data from at least one of the fast data storage device and the slow data storage device to the cache based the distribution of data determined by the tiering management processor.

10. The apparatus of claim 9, wherein the software executing on the cache management processor is further configured to analyze individual input/output operations.

11. The apparatus of claim 10, wherein the software executing on the cache management processor is further configured to identify data from two or more regions of at least one of the fast data storage tier and the slow data storage tier that would be more efficiently accessed if stored in a single region.

12. The apparatus of claim 11, wherein the software executing on the cache management processor is further configured to combine the data from the two or more regions into a single region.

13. The apparatus of claim 11, wherein the software executing on the tiering management processor is further configured to combine the data from the two or more regions into a single region.

14. The apparatus of claim 10, wherein the software executing on the tiering management processor is further configured to modify the distribution based on the input/output operations analysis.

15. The apparatus of claim 9, wherein the software executing on the tiering management processor is further configured to move data between the fast data storage tier and the slow data storage tier in response to a data access operations analysis.

16. The apparatus of claim 9, wherein the software executing on the cache management processor is further configured to replicate data only from the slow data storage tier.

17. A method for distributing data in a tiered data storage system comprising:
analyzing data access operations of one or more tiers in the tiered data storage system over a period of time with a tiered management subsystem;
determining a distribution of data in the tiered data storage system based on a data access operations analysis; and
replicating data from at least one tier in the tiered data storage system onto a cache with a cache management subsystem in response to the distribution.

18. The method of claim 17, further comprising analyzing individual input/output operations with a cache management subsystem.

19. The method of claim 18, further comprising identifying data from two or more regions of at least one tier in the tiered data storage system that would be more efficiently accessed if stored in a single region.

20. The method of claim 19, further comprising combining the data from the two or more regions into a single region

21. The method of claim 18, further comprising modifying the distribution based on the input/output operations analysis.

22. The method of claim 17, further comprising moving data between the one or more tiers in the tiered data storage system in response to the data access operations analysis.

23. The method of claim 17, wherein replicating data from at least one tier in the tiered data storage system onto a cache replicates data only located on a slow tier.
